(19) United States
(12) Patent Application Publication
(10) Pub. No.: US 2009/0007399 A1
(43) Pub. Date: Jan. 8, 2009

(54) Structure for interrlocking two members

(75) Inventors: Yasuhiro Sato, Tokyo (JP); Yoshinori Wakana, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: NILES CO., LTD., Tokyo (JP)

(21) Appl. No.: 12/216,388

(22) Filed: Jul. 3, 2008

(30) Foreign Application Priority Data
Jul. 6, 2007 (JP) 2007-178289

(51) Int. Cl. F16B 2/20

(52) U.S. Cl. 24/458

(57) ABSTRACT

A strength of engagingly locking a second member to a first member is remarkably improved without causing deterioration in workability, even when improvement in the locking strength between two members is attempted using a clip. In order to lock and fix a connector housing 19 to a rotor housing 15 in an erected state, an engagement force occurs and acts between a locking claw 27 and a locking part 45, via an insertion locking male part 29 provided in a connector housing 19. By this engagement force, the movement of the insertion locking male part 29 in the inserting/extracting direction is regulated. Further, by inserting the clip 23 from the direction almost at a right angle to the inserting direction of the insertion locking male part 29, a mechanical mutual action occurs between the clip 23 and a pair of insertion engagement parts 40a and 40b, thus secondarily regulating the movement of the insertion locking male part 29 in the inserting/extracting direction.

### BACKGROUND

1. Technical Field

The present invention relates to a structure for interlocking two members for locking and fixing a second member to a first member in an erected state. In particular, the present invention relates to a structure for interlocking two members, which is capable of remarkably improving strength of engagingly locking the second member to the first member.

2. Background Art

Conventionally, in order to further improve the strength of engagingly locking the second member to the first member, a technique of using a metal clip is known (Patent document 1).

A connector housing with a latching mechanism of patent document 1 is composed of a pair of mutually engaging connector housings engaged, with one of the connector housings having a rotatable latching member, having a pair of elastic latching arms with tips bent inward, a center column, and an operating part; and the other connector housing having a cavity surrounded by front, rear, and side walls, and having a latching means into which the latching member is inserted. This latching means has a center partition wall, having formed therein a first cam member having a pair of inclined surfaces in a shape widening toward the end in the engagement direction, and has a pair of second cam members formed in an inverted triangle shape with inclined surfaces thereof. During engagement and extraction, the latching arm is engaged with each of the inclined surfaces of the first cam member and second cam member. A continuous slot is formed in the latching arm, extending from the front end of one latching arm to the front end of the other latching arm, and a C-shaped plate sheet-like metal spring clip is inserted into this slot. By facilitating a retaining strength of the latching member during engagement and extraction by insertion of such a clip, the strength of engagingly locking a connector can be increased.

However, in such a conventional structure for interlocking two members, when further improvement in the locking strength is attempted, deterioration in workability during fitting the clip is liable to occur.

Namely, in the conventional structure for interlocking two members, insertion of the latching member (latching arm) and insertion of the clip are directed to the same direction. Therefore, in order to insure the holding power against external force, when a predetermined external force is applied to the latching member in a direction of inserting/extracting the latching member, the deflection strength of the clip itself must be increased. In this case, as a result of requiring a push-in force exceeding the deflection strength, the deterioration in workability is liable to occur.

Patent Document 1

Japanese Patent Laid Open No. 07-6818 (see FIG. 1 and paragraph 0019)

A problem to be solved by the invention is that the strength of engagingly locking the second member to the first member is remarkably improved without causing the deterioration in workability, when the improvement in the strength of interlocking two members is attempted using the clip.

### SUMMARY OF THE INVENTION

An object of the present invention is to dramatically improve a strength of engagingly locking a second member to a first member, without causing deterioration in workability even when the strength of interlocking two members is obtained by using a clip, and provides a structure for interlocking two members, including a first member in which an insertion locking female part having a locking part inside is formed in an fitting part; and a second member provided with an insertion locking male part which is disposed in the fitting part in an erected state and has a locking claw inserted into the insertion locking female part to engage with the locking part, for engagingly locking and fixing the second member to the first member in an erected state, with the first member having a clip insertion part that communicates from inside of the insertion locking female part to a direction crossing the inserting direction of the second member so as to open to outside of the fitting part, and having a clip inserted from the opening to the clip insertion part to face the insertion locking female part side, and with the insertion locking male part having a butting member that abuts on the clip from the inserting/extracting direction.

In a conventional structure for interlocking two members, the insertion of the latching member and the insertion of the clip are directed to the same direction. Therefore, when a predetermined external force is applied to the latching member in the inserting/extracting direction, the deflection strength of the clip itself must be increased to insure a holding power against the external force. In this case, as a result of requiring a push-in force exceeding the deflection strength during fitting the clip, deterioration in workability is liable to occur.

Meanwhile, in the structure for interlocking two members, according to the present invention, the second member is engagingly locked and fixed to the first member in an erected state. Therefore, when the insertion locking male part formed in the second member is inserted into the insertion locking female part, an engagement force of the locking claw that engages with the locking part in the inserting/extracting direction is applied, and, in combination with such an engagement force, a mechanical mutual action occurs between the clip inserted from the direction crossing the inserting direction of the insertion locking male part and the butting member in the insertion locking male part, so as to cooperatively act to regulate a movement of the insertion locking male part in the inserting/extracting direction. Accordingly, even when the improvement in the strength of interlocking two members is attempted using the clip, the strength of engagingly locking the second member to the first member can be remarkably improved without causing the deterioration in workability.

### BRIEF DESCRIPTION OF THE DRAWINGS

FIG. 1 is an exploded perspective view of a rotor housing and its periphery, showing an outline of a locking structure according to an example of the present invention;

FIG. 2 is an exploded perspective view of the rotor housing and its periphery, showing the outline of the locking structure according to an example of the present invention;

FIG. 3 is a perspective view of a connector housing serving as a constituent element of an example of the present invention;

FIG. 4 is a perspective view of a clip serving as a constituent element of an example of the present invention;

FIG. 5 is a perspective view showing a fitting state of the clip to the connector housing;

FIG. 6 is a sectional perspective view of an essential part, showing the fitting state of the clip to the rotor housing;

FIG. 7 is a perspective view showing the fitting state of the clip to the rotor housing;

FIG. 8 is a partial sectional perspective view, showing the fitting state of the clip to the connector housing;

FIG. 9 is a partial sectional perspective view, showing a modified example of fitting state of the clip to the connector housing;

FIG. 10 is a sectional perspective view of an essential part, showing the fitting state of the connector housing and the clip to the rotor housing; and

FIG. 11 is a sectional view of an essential part, showing the fitting state of the connector housing and the clip to the rotor housing.

### BEST MODE FOR CARRYING OUT THE INVENTION

It is possible to realize the object of improving the strength of engagingly locking the second member to the first member, without causing deterioration in workability, even when the improvement in the strength of interlocking two members is attempted using the clip, by providing to the insertion locking male part the butting member that abuts on the clip inserted from the direction crossing the inserting direction of the locking insertion part, from the inserting/extracting direction of the insertion locking male part.

### Embodiment(s)

A detailed description will be given hereinafter with respect to a rotor housing of a rotary connector device for making electrical connection between a body side power supply of an automobile and an electric system of a steering wheel provided as an example of the first member, and with a connector housing fitted to the rotor housing provided as an example of the second member engagingly locked to the first member.

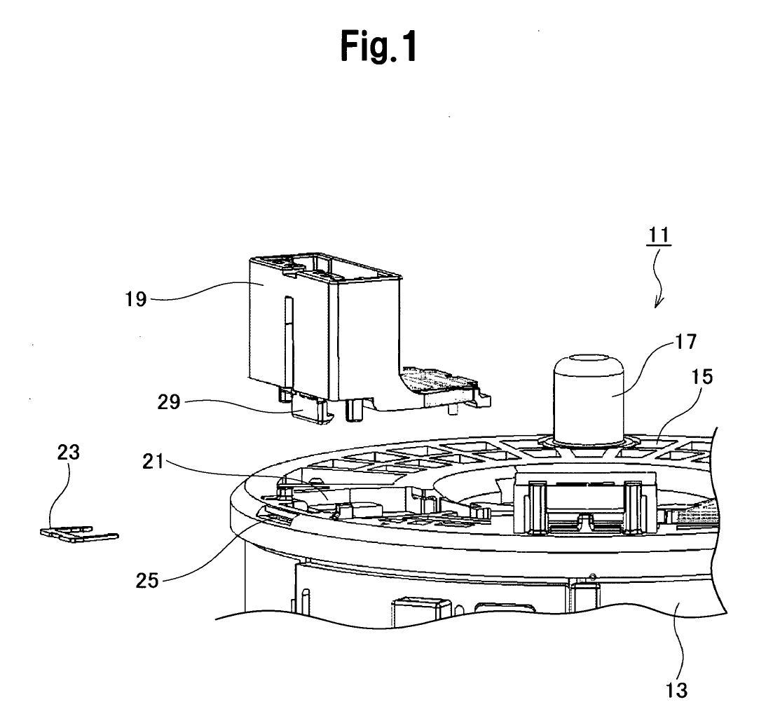

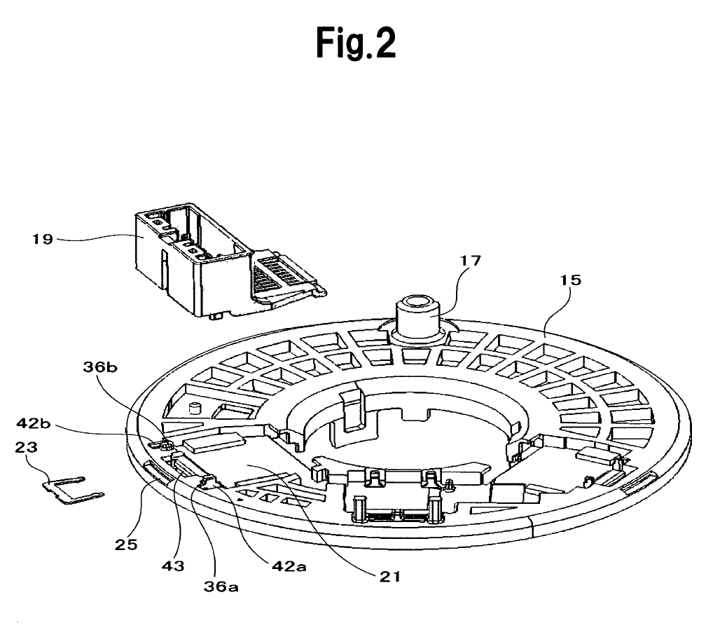

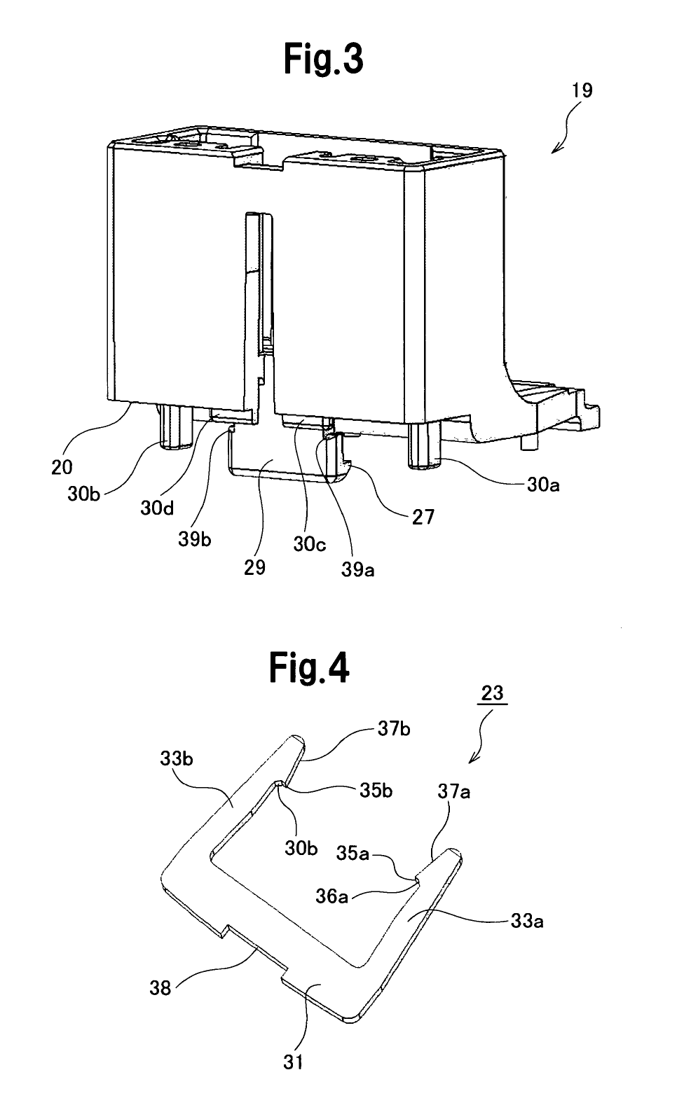

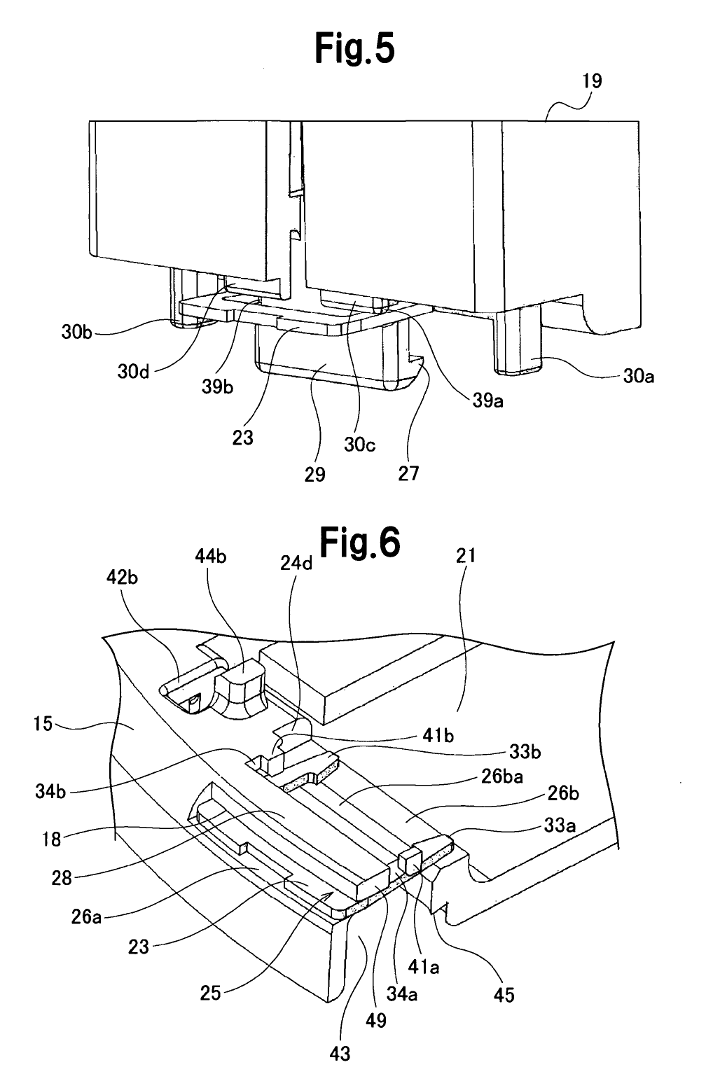

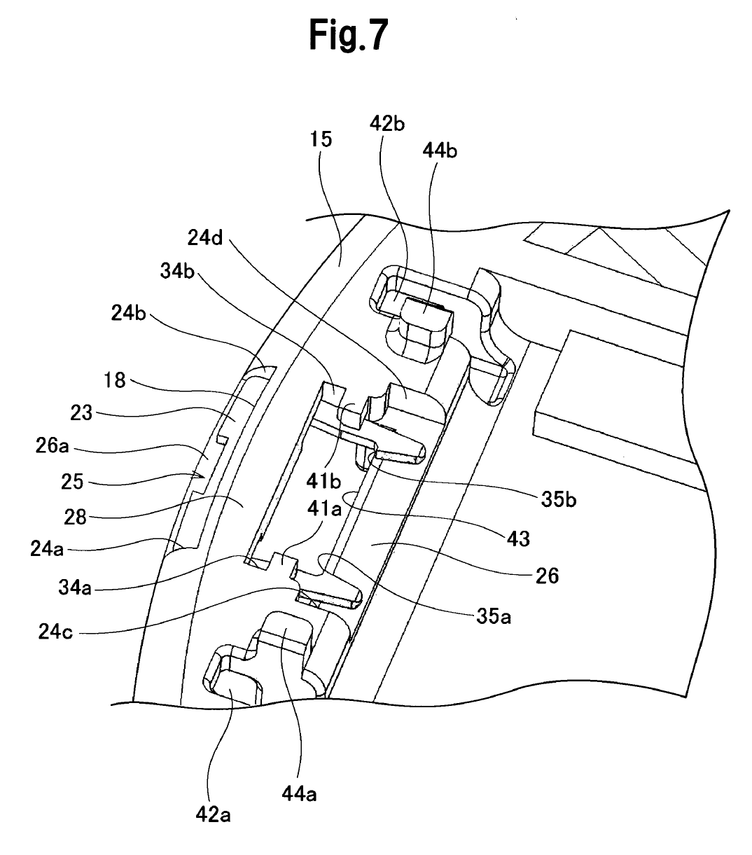

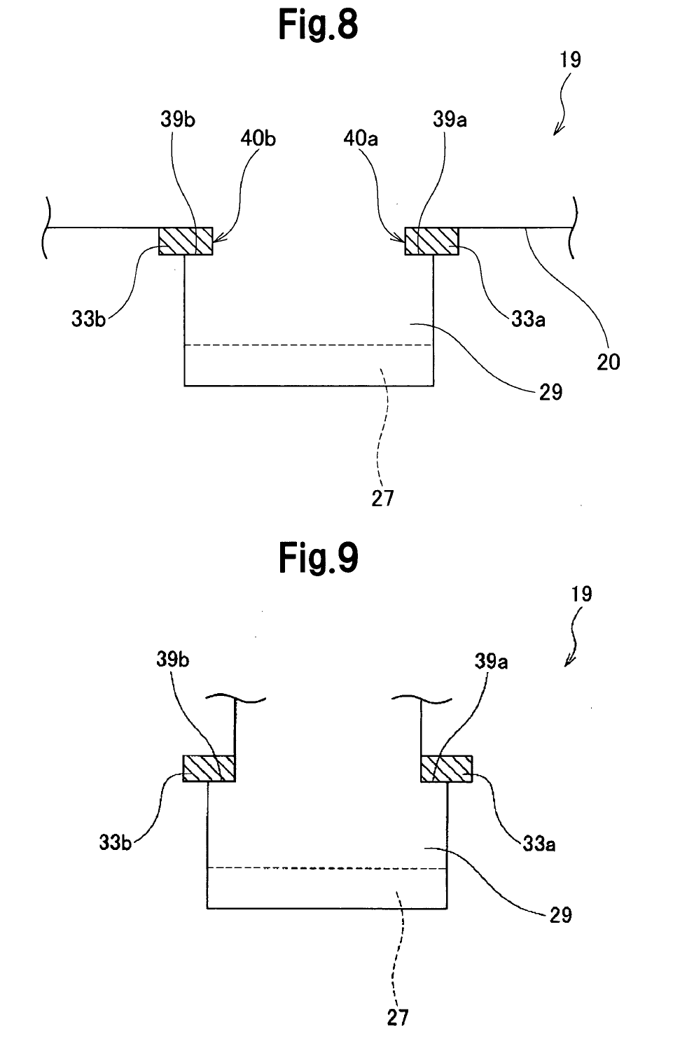

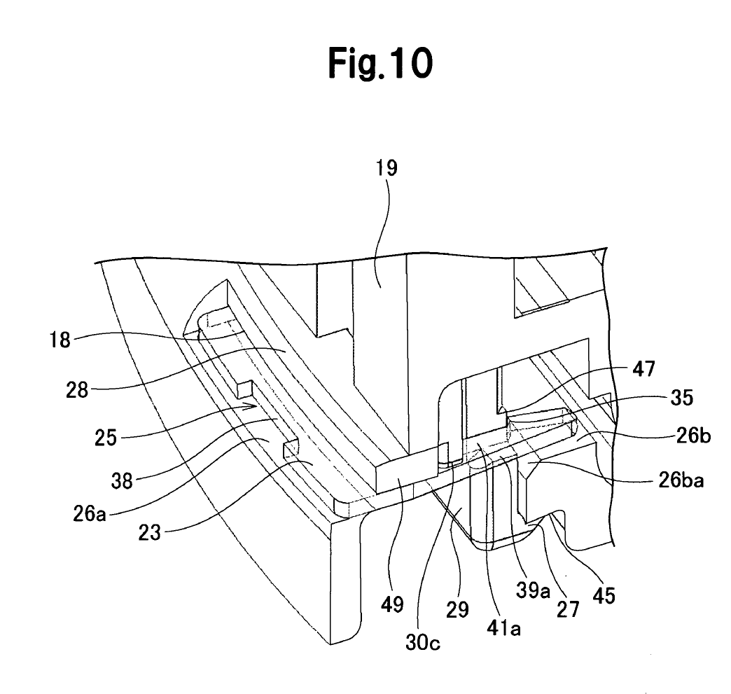

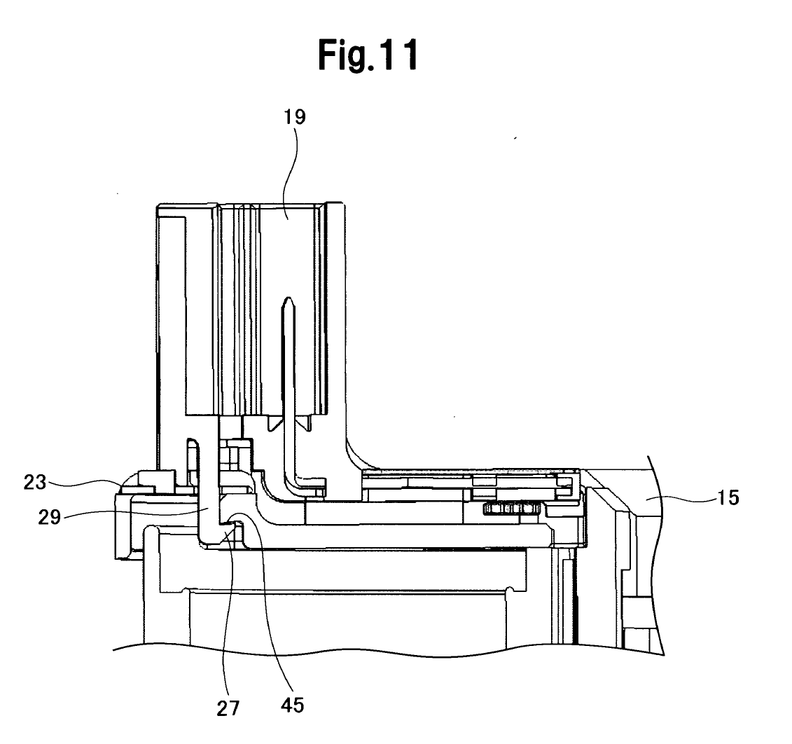

FIGS. 1 and 2 are broken perspective views of the rotor housing and its periphery, showing an overview of the locking structure according to an example of the present invention; FIG. 3 is a perspective view of the connector housing serving as a constituent element of an example of the present invention; FIG. 4 is a perspective view of the clip serving as a constituent element of an example of the present invention; FIG. 5 is a perspective view of a state in which the clip is fitted to the connector housing; FIG. 6 is a sectional perspective view of an essential part, showing a state in which the clip is fitted to the rotor housing; FIG. 7 is a perspective view showing a state in which the clip is fitted to the rotor housing; FIG. 8 is a partial sectional perspective view showing a state in which the clip is fitted to the connector housing; FIG. 9 is a partial sectional perspective view showing an exemplary modification of fitting the clip to the connector housing; FIG. 10 is a sectional perspective view of an essential part, showing a state in which the connector housing and the clip are fitted to the rotor housing; and FIG. 11 is a sectional view of an essential part, showing a state in which the connector housing and the clip are fitted to the rotor housing.

As shown in FIGS. 1 and 2, a rotary connector device 11 is constituted, so as to have a function of making electrical connection between the body side power supply of the automobile (not shown) and the electric system of the steering wheel (not shown), including a stator housing 13 fixed to the body side and a substantially donut-shaped rotor housing 15 rotatably mounted on this stator housing 13.

The rotor housing 15 corresponding to the first member of the present invention is molded by engineering plastic such as POM resin, and is coupled to a steering handle (not shown) by a coupling pin 17. On an upper surface of the rotor housing 15, a connector fitting part (corresponding to the “fitting part” of the present invention) 21 is provided for fitting a connector housing (corresponding to the “second member” of the present invention) 19 for connecting an electric system harness (not shown) of the steering wheel.

In this way, as shown in FIGS. 1, 2, 6, 7, 8, 10, and 11, an insertion locking female part 43 is provided in the connector fitting part 21. On one side of the inside of the insertion locking female part 43, a locking part 45 is provided for engaging with a locking claw 27 of an insertion locking male part 29 as will be described later. In addition, a clip insertion part 25, into which a clip 23 is inserted, is opened on the rotor housing 15 toward its circumferential side.

The clip insertion part 25 is formed, so as to communicate from inside of the insertion locking female part 43 to a direction crossing the inserting direction so as to open to the outside of the connector fitting part 21. The clip insertion part 25 is formed between left and right walls 24a, 24b, 24c, 24d, slide walls 26a, 26b, and a beam part 28. The part between the left and right walls 24a, 24b, the slide wall 26a, and the beam part 28 is formed to be closed, and the outside thereof is formed in an opening 18 for inserting the clip 23.

The side opposite to the slide wall 26a of the beam part 28 is constituted as a first abutment member 49 that makes the clip 23 abut thereon. The first abutment member 49 has a guide function, during insertion of the clip 23. An inclined surface 26ba for guiding the clip 23 is formed on the slide wall 26b.

Projections 41a and 41b are formed oppositely to the beam part 28, on the left and right walls 24a, 24b, at intervals of 34a and 34b. The projections 41a and 41b are positioned on an inlet side of the insertion locking female part 43, and constitute a second abutment member. The left and right walls 24c and 24d are formed stepwise so as to expand a distance to the left and right walls 24a and 24b, to allow expanding behavior of the clip 23.

Positioning projections 44a and 44b that engage with the connector housing 19 are provided on both sides of the connector fitting part 21. Also, positioning recess portions 42a and 42b are provided outside of the projections 44a and 44b.

As shown in FIG. 3, the connector housing 19 of the example corresponding to the second member of the present invention is molded by thermoplastic engineering plastic such as PBT resin (Polybutylene terephthalate). The insertion locking male part 29 having the locking claw 27 is provided integrally with the connector housing 19 so as to extend from its bottom surface. Also, positioning projections 30a, 30b, 30c, and 30d to the rotor housing 15 are provided integrally with a lower surface 20 of one side of the connector housing 19 so as to extend from its bottom surface. The projections 30a and 30b are engaged with the recess portions 42a and 42b of the rotor housing 15, and the projections 30c and 30d are fitted into the intervals 34a and 34b between the beam part 28 and the projections 41a, 41b.

As shown in FIG. 4, the clip 23 has a function of engagingly locking the insertion locking male part 29 provided in the connector housing 19, to the rotor housing 15. The clip 23 has a base part 31 and a pair of arm parts 33a and 33b extending in an approximately perpendicular direction from both ends of the base part 31, and is integrally formed by a suitable resin material in an approximately U-shape. A pair of claw parts 35a and 35b for engaging with the insertion locking male part 29 so as to hold it therein are provided on end portions of the pair of arm parts 33a and 33b in the inserting direction. The insides of the base parts of the claw parts 35a and 35b are formed as inclined surfaces 36a and 36b. A holding power is given by the arm parts 33a and 33b, so that the inclined surfaces 36a and 36b are abutted on a corner portion of an abutment member 47 of the insertion locking male part 29.

In addition, inclined surfaces 37a and 37b for giving a spring force to the insertion locking male part 29 during insertion of the clip 23 are formed in a pair of claw parts 35a and 35b. Further, a notch part 38 for receiving a jig during insertion of the clip 23 is formed on the base part 31 on the backside of the clip 23 in the inserting direction.

As shown in FIG. 3 and FIG. 5, a pair of insertion engagement parts 40a and 40b is formed in the insertion locking male part 29 of the connector housing 19. The insertion engagement parts 40a and 40b have a function of smoothly fitting the clip 23 and positioning the connector housing 19 to the clip 23 in the erecting direction of the connector housing 19. The insertion engagement parts 40a and 40b are formed, so that a pair of butting members 39a and 39b on both sides of the insertion locking male part 29 is opposed to the lower surface 20 of one side of the connector housing 19.

In a process of inserting the clip 23 into the insertion locking male part 29, the clip 23 is smoothly fitted into the insertion locking male part 29 by guiding the pair of claw parts 35a and 35b provided in the clip 23 into the pair of insertion engagement parts 40a and 40b, while in slide-contact with the insertion engagement parts 40a and 40b.

Further, when the clip 23 has been fitted into the insertion locking male part 29, as shown in FIG. 10, the pair of arm parts 33a and 33b in the clip 23 is engaged with the pair of insertion engagement parts 40a and 40b, and an engagement action occurs between the clip 23 and the pair of insertion engagement parts 40a, 40b, thus reliably regulating a movement of the insertion locking male part 29 in the inserting/extracting direction.

### Action(s) of the Embodiment(s)

Incidentally, in engagingly locking and fixing the connector housing 19 to the rotor housing 15, first, the connector housing 19 is positioned and fitted into the connector fitting part 21 in the rotor housing 15. During the fitting of the connector housing 19, the insertion locking male part 29 of the rotor housing 15 is inserted into the insertion locking female part 43 (see FIG. 7) of the rotor housing 15

Then, the locking claw 27 in the insertion locking male part 29 is coupled to, and engaged with, the locking part 45 provided on the side of the rotor housing 15 (see FIGS. 10 and 11), via elastic displacement of the insertion locking male part 29. By such a coupling engagement, the movement of the insertion locking male part 29 in the inserting/extracting direction is primarily regulated.

At this time, the projections 30a and 30b of the connector housing 19 are engaged with the recess portions 42a and 42b of the rotor housing 15, and the projections 44a and 44b of the rotor housing 15 are engaged with the connector housing 19. The projections 30c and 30d of the connector housing 19 are engaged with the intervals 34a and 34b.

Next, in a state in which the connector housing 19 is engaged with the rotor housing 15, the clip 23 is press-fitted into the clip insertion part 25 from the opening 18. During such press-fitting of the clip 23, a jig (not shown) is set in the notch part 38 of the clip 23, and the clip 23 is engaged with the clip insertion part 25, via this jig. This makes it possible to increase the workability.

Note that, in the insertion process of the clip 23, the clip 23 is smoothly fitted into the insertion locking male part 29 by guiding the pair of claw parts 35a and 35b provided in the clip 23 into the pair of insertion engagement parts 40a and 40b in the insertion locking male part 29, while in slide-contact with the insertion engagement parts 40a and 40b.

In addition, when the clip 23 has been fitted, the claw part 35 in the clip 23 acts to hold the insertion locking male part 29 between the clip 23 and the abutment member 47 on the backside of the insertion locking male part 29 (see FIG. 10). Tips of the arm parts 33a and 33b perform slide-movement on the slide wall 26b. Sliding of the tips of the arm parts 33a and 33b is smoothly guided by the inclined surfaces 26b and 26a. When the claw part 35 of the clip 23 is engaged with the abutment member 47 to hold the abutment member 47, the spread of the tips of the arm parts 33a and 33b is allowed by the interval between the left and right walls 24c, 24d.

The pair of arm parts 33a and 33b in the clip 23 are engaged with the pair of insertion engagement parts 40a and 40b in the insertion locking male part 29, and a mechanical mutual action occurs between the clip 23 and the pair of insertion engagement parts 40a, 40b, thus secondarily regulating the movement of the insertion locking male part 29 in the inserting/extracting direction.

Namely, during assembly, when a leaning force (applied to the center side of the radial direction of the rotor housing 15) acts on the connector housing 19 fitted to the connector fitting part 21 in an erected state as described above, via a harness, the locking claw 27 is liable to be detached from the locking part 45, due to rotation of the connector housing 19.

At this time, a rotational force is transferred to the arm parts 33a and 33b of the clip 23 from the insertion locking male part 29 in the insertion engagement parts 40a and 40b, and the arm parts 33a and 33b are abutted on the first abutment member 49 of the projections 41a and 41b. By this abutment, the rotational force of the arm parts 33a and 33b is received, and an erected posture of the connector housing 19 is maintained.

Accordingly, the locking claw 27 is hardly disengaged from the engagement part 45, thus making it possible to firmly maintain the erected posture of the connector housing 19.

In addition, the rotational force transferred to the arm parts 33a and 33b is also received by the tips abutting on the slide wall 26b, thus making it possible to firmly maintain the erected posture of the connector housing 19.

Further, the projections 30c and 30d are abutted on, and are engaged with, the beam part 28, by the behavior of the connector housing 19 in a leaning direction, thus making it possible to further firmly maintain the erected posture of the connector housing 19.

Regarding the force in a coming-off direction of the connector housing 19, the locking claw 27 is engaged with the locking part 45, and a load is transferred to the clip 23 from the butting members 39a and 39b, and the movement of the clip 23 is received by the projections 41a and 41b and the first abutment member 49. Accordingly, the connector housing 19 can be reliably supported by the connector fitting part 21.

### Effects of the Embodiment(s)

In the structure for interlocking two members according to a conventional art, the insertion of the latching member and the insertion of the clip are directed to the same direction. Therefore, in order to ensure the holding power against an external force, when a predetermined external force is applied to the latching member in a direction of inserting/extracting the latching member, the deflection strength of the clip itself must be increased. In this case, a push-in force exceeding the deflection strength is required, often resulting in the deterioration in workability.

Meanwhile, in the structure for interlocking two members, according to the example of the present invention, the connector housing 19 is engagingly locked and fixed to the rotor housing 15 in an erected state. Therefore, the engagement force occurs and acts between the locking claw 27 and the locking part 45, via the insertion locking male part 29 provided in the connector housing 19, thereby primarily regulating the movement of the insertion locking male part 29 in the inserting/extracting direction. Further, when the clip 23 inserted from the direction almost at a right angle to the inserting direction of the insertion locking male part 29 is set in an engagingly locked state, the pair of arm parts 33a and 33b in the clip 23 are engaged with the pair of insertion engagement parts 40a and 40b in the insertion locking male part 29, thus allowing a mechanical mutual action to occur between the clip 23 and the pair of insertion engagement parts 40a and 40b, thereby secondarily regulating the movement of the insertion locking male part 29 in the inserting/extracting direction.

Thus, the connector housing 19 is engagingly locked to the rotor housing 15 by very simple work, in which the locking claw 27 is elastically coupled to the locking part 45 and the clip 23 is press-fitted into the clip insertion part 25, in such a manner that mutually independent two mechanisms act cooperatively with each other so as to regulate the movement of the locking insertion male part 29 in the inserting/extracting direction. Accordingly, even when an improvement in the strength of engagingly locking the connector housing 19 is attempted using the clip 23, the strength of engagingly locking the connector housing 19 to the rotor housing 15 can be remarkably improved without causing the deterioration in workability.

In addition, for example, in the step of assembling the rotary connector device 11 in a vehicle body, when the connector housing 19 is engagingly locked and fixed to the rotor housing 15 and the electric harness of the steering wheel is connected to the connector housing 19, the connector housing 19 can be tilted by pulling of the electric harness by a worker, thus disengaging the locking claw 27 and the locking part 45 from each other. However, in the structure for interlocking two members, according to the example of the present invention, even if such a circumstance occurs, the pair of arm parts 33a and 33b in the clip 23 are engaged with the pair of insertion engagement parts 40a and 40b (see FIG. 8), and the mechanical mutual action occurs, thereby regulating the movement of the insertion locking male part 29 in the inserting/extracting direction. Therefore, the connector housing 19 is not unlocked from the rotor housing 15. Accordingly, it is possible to provide the structure for interlocking two members having excellent locking strength of the connector housing 19 to the rotor housing 15. Here, instead of a mode in which the pair of arm parts 33a and 33b in the clip 23 are engaged with the pair of insertion engagement parts 40a and 40b (see FIG. 8), as shown in FIG. 9, it is possible to employ a structure in which the connector housing 19 is prevented from falling off from the rotor housing 15, by causing the clip 23 to abut on the stepwise butting members 39a and 39b formed in the insertion locking male part 29.

Further, in the structure for interlocking two members, according to claims 2 to 4 of the present invention, as shown in FIG. 8 to FIG. 11, the direction of engagement of the locking claw 27 of the insertion locking male part 29 with the locking part 45 of the rotor housing 15 is set as a direction different from the direction of inserting the clip 23. Therefore, for example, in the step of assembling the rotary connector device 11 in the vehicle body, the connector housing 19 is tilted in an axial direction of the rotary connector device 11 by pulling the electric harness by a worker in an axial direction of the rotary connector device 11, thereby almost disengaging the locking claw 27 and the locking part 45 from each other. Even in such a case, the tilting force of the connector housing 19 is transferred to the clip 23 by engaging with the pair of insertion engagement parts 40a and 40b, and when this clip 23 is abutted on the first abutment member 49 formed on the circumferential surface of the opening of the clip insertion part 25 opened on the rotor housing 15, it is possible to firmly support the clip 23 (see FIG. 6 and FIG. 10). Accordingly, the clip 23 is firmly supported in the rotor housing 15, thus making it possible to effectively suppress a tilting force of the connector housing 19. As a result, it is possible to provide the structure for interlocking two members having significantly excellent locking strength of the connector housing 19 to the rotor housing 15.

### Additional Embodiment(s)

The present invention is not limited to the aforementioned examples, and can be suitably modified without departing from the scope of claims and the gist of the invention or a technical concept that can be read from the entire specification, and the structure for interlocking two members thus modified can also be incorporated in a technical scope of the present invention.

Namely, in the examples of the present invention, a description is given with respect to the rotor housing 15 of the rotary connector device 11 as the first member, and the connector housing 19 coupled to the rotor housing 15 as the second member. However, the present invention is not limited thereto, and the structure for interlocking two members, according to the present invention, can be applied to all of the fields in which engagingly locking and fixing between two members is required.

Further, in the examples of the present invention, a description is given with respect to a female-type connector housing 19 as the second member engagingly locked to the first member. However, the present invention is not limited thereto, and needless to say, a male-type connector housing 19 can be employed as the second member engagingly locked to the first member.

1. A structure for interlocking two members, comprising:
a first member in which an insertion locking female part having a locking part therein is formed in a fitting part;
a second member including an insertion locking male part having a locking hook disposed in the fitting part in an erected state and inserted into the insertion locking female part to engage with the locking part,
the second member being locked and fixed to the first member in an erected state,
with the first member including a clip insertion part that communicates from inside of the inserting direction of the second member so as to open to outside of the fitting part, and including a clip inserted from the opening to the clip insertion part so as to face the side of the insertion locking female part, and
with the insertion locking male part including butting members that abut on the clip from the inserting/extracting direction.

2. The structure form interlocking two members, according to claim 1, wherein the butting members are provided on both sides of the insertion locking male part in the inserting direction of the clip, and
the clip has a pair of arm parts on which both of the butting members are abutted thereon at an inserting position of the clip into the clip insertion part.

3. The structure for interlocking two members, according to claim 1 or 2, wherein the clip comprises a claw part that engages with the insertion locking male part.

4. The structure for interlocking two members, according to claim 3, wherein the butting members provided in the insertion locking male part are a part of an insertion engagement part provided in the second member, into which the clip is fitted at an inserting position, and the clip insertion part is formed in opposite to the butting members at a position on the opening side further than the butting members, including an abutment member that makes the clip abut thereon.

5. The structure for interlocking two members, according to claim 4, wherein the clip has a notch part formed therein, for receiving a jig during insertion of the clip.

6. The structure for interlocking two members, according to claim 5, wherein the first member is rotor housing of a rotary connector device, and the second member is a connector fitted to the rotor housing.

7. The structure for interlocking two members, according to any one of claims 1 or 2, wherein the butting members provided in the insertion locking male part are a part of an insertion engagement part provided in the second member, into which the clip is fitted at an inserting position, and the clip insertion part is formed in opposite to the butting members at a position on the opening side further than the butting members, including an abutment member that makes the clip abut thereon.

8. The structure for interlocking two members, according to claim 7, wherein the clip has a notch part formed therein, for receiving a jig during insertion of the clip.

9. The structure for interlocking two members, according to claim 8, wherein the first member is rotor housing of a rotary connector device, and the second member is a connector fitted to the rotor housing.

10. The structure for interlocking two members, according to any one of claim 1 or 2, wherein the clip has a notch part formed therein, for receiving a jig during insertion of the clip.

11. The structure for interlocking two members, according to claim 10, wherein the first member is rotor housing of a rotary connector device, and the second member is a connector fitted to the rotor housing.

12. The structure for interlocking two members, according to claim 3, wherein the clip has a notch part formed therein, for receiving a jig during insertion of the clip.

13. The structure for interlocking two members, according to claim 12, wherein the first member is rotor housing of a rotary connector device, and the second member is a connector fitted to the rotor housing.
